(19) United States
(12) Patent Application Publication
(10) Pub. No.: US 2005/0095334 A1
(43) Pub. Date: May 5, 2005

(54) Bakery method and mold therefor

(76) Inventor: Salvatore Messina, Waterdown, CA (US)

Correspondence Address: Ralph A. Dowell;Dowell & Dowell, P.C., Suite 406, 2111 Eisenhower Ave, Alexandria, VA, 22314, US

(21) Appl. No.: 10/942,783

(22) Filed: Sep. 17, 2004

Related U.S. Application Data
(60) Provisional application No. 60/503,486, filed on Sep. 17, 2003.

(51) Int. Cl. A01J 1/00

(52) U.S. Cl. 426/512

(57) ABSTRACT

A mold in one configuration has a pair of generally planar side walls having joined lower edges and extending upward from the lower edges at an obtuse angle to each other and a pair of generally rectangular end walls crosswise to the side walls and forming therewith an elongated cavity. A plurality of such side and end walls can be joined together at upper edges of the side walls to form a plurality of such cavities extending horizontally parallel to one another. Each cavity can also be provided with at least one crosswise partition and/or a cover. A foodstuff is made by first filling the cavity with a mass of risable dough. Either before or during baking a branding implement with either recessed or protruding areas is inserted into the cavity appropriately sized and shaped to permit the dough to rise and form around the specific logo or brand desired. The branding element can also be fabricated as integral to the cavity. The dough mass is cooked so the dough rises and forms a baked food product. The cooked dough mass is then demolded exposing the branding.

This application claims priority from U.S. Provsional Application 60/503,486 filed Sep. 17, 2003.

### FIELD OF INVENTION

The present invention relates to a foodstuff mold. More particularly this invention concerns such a mold and a method of making a branded foodstuff, for instance, a cookie, bread, or cake.

### BACKGROUND OF THE INVENTION

In order to produce a baked good such as a cookie, cake, or bread, it is standard to place a liquid or semi-solid dough or the like into a mold and then bake the dough until it rises. Once the foodstuff is ready, either after baking or chilling, it is demolded and the mold can be reused. Specialty-shaped baked goods are also well-known. For example, conventional hot dog or hamburger buns are very common.

Various devices or means have also been invented to mold a recess or hollow into a bun or other baked product. The following references were disclosed in the prior art: U.S. Pat. No. 3,747,508, Elam; U.S. Pat. No. 3,943,840, Bolte; U.S. Pat. No. 4,047,477, Berke; U.S. Pat. No. 4,190,229, Bradshaw; U.S. Pat. No. 4,311,716, Launay; and U.S. Pat. No. 6,200,620, Brinker. In Launay, a process application, involves a piston configuration within a cavity having fixed members to form the mold, the piston giving way to moldable material brought into the cavity. That device is suggestive of the pans with a center core, particularly those having a removable bottom, used to make a tall cake with a hollow cylindrical center. The other five have in common a forming means, generally of rod-like configuration, held within dough during the baking process and afterwards extracted therefrom.

The foregoing devices in the prior art have in common the baking of material within a mold. The present invention allows dough to rise freely, the molding being accomplished only upon a part of the dough by reason of its weight upon the underlying surface of the branding implement. With the inventions cited, the surface of all or most of the dough or other material is not permitted to rise, brown and crisp exposed to the ambient heated oven air as would the top of a baking loaf of bread.

It is common knowledge that there is consumer appeal in baked products with a low porosity, smooth, crisp and shining surface texture which those rising unrestricted and browning within an oven exhibit. Hot dog and hamburger buns baked in the traditional commercial bakery manner, without channeled or hollowed interiors, rise and brown in that appealable fashion and this invention preserves that characteristic.

The cost and, therefore, the limitation upon practical accessibility to individuals of the items cited from prior art exceeds considerably that of the present invention. That for the Launay device would depend upon the intended level of use—that is, whether employed commercially or made available by more simple manufacture for individual kitchen use. The other inventions cited, while suitable for large scale commercial bakery use, of necessity, require substantial capital investment. The present invention has no moving parts, and consists of no more than sufficiently rigid material, shaped with appropriate protrusions or recesses, to retain its configuration during the baking process. It is, therefore, affordably accessible to retail bakeries operating below the large scale commercial manufacturing level.

The invention's low manufacturing cost, simplicity of construction and compactness also make it feasible for food item producers to include it in the packages for retail items such as frozen dough or baking flour.

### OBJECTS OF THE INVENTION

It is therefore an object of the present invention to provide an improved foodstuff mold.

Another object is the provision of an improved method of making a branded foodstuff.

It is another object of the invention to provide a branding element, having either protrusions or recesses, that is used to brand baked goods, having embossed or effaced surfaces.

It is yet another object of the present invention to provide both separate branding elements and those integral to a bakery mold.

It is another object of the invention to provide a method of making a branded baked good that can be distributed via fresh or frozen distribution means.

### SUMMARY OF THE INVENTION

A mold in one configuration has a pair of generally planar side walls having joined lower edges and extending upward from the lower edges at an obtuse angle to each other and a pair of generally rectangular end walls crosswise to the side walls and forming therewith an elongated upwardly U-shaped cavity. A plurality of such side and end walls can be joined together at upper edges of the side walls to form a plurality of such cavities extending horizontally parallel to one another.

A branding element is used together with the mold to produce branded food products such as bread, cakes or cookies. The branding element may be separate or integral to the mold. The branding element may be constructed from a variety of materials such as wood, metal, or plastic such as teflon or other light weight, food-grade plastics.

A branded foodstuff is made according to the invention by first filling a U-shaped cavity of a mold joined to each with a mass of risable dough. Before or after some rising of the dough a branding element is introduced with the dough mass and the dough mass is cooked so the dough rises and expands into the branding element. Then the cooked dough mass is demolded exposing the brand.

With this system, therefore, it is also possible to create a substantial number of the baked foodstuff at one time. The result is an extremely cost-effective way to make branded cookies, cakes, breads, and the like.

The present invention is a simple and economical heat resistant implement configured with folds or recesses of sufficient height to form within bread dough placed upon it. It may be characterized as belonging to the following field: A food preparation accessory; more particularly, a baking aid for specialty shaped bread

The present invention may be constructed of any heat resistant material, whether sheet metal, glass, high temperature tolerant plastic, ceramic or other durable material. It may be coated with some low friction substance extant in other areas of the prior art than those of concern here to facilitate separation of the baked product from the baking mold and branding implement. A more rigid material such as that commonly produced with tin, sheet alloyed metal or ceramics might feasibly be retailed along with other kitchen ware.

Baking would likely be accomplished in any conventional gas, electric or microwave oven or in commercial baking ovens.

### BRIEF DESCRIPTION OF THE DRAWINGS

The apparatus of the invention will now be described with reference to the accompanying drawings, in which:

FIGS. 1 and 2 are perspective views of molds according to the invention with integral branding implement;

FIG. 3 is a perspective view of a baked foodstuff produced with the invention;

FIG. 4 is a perspective view of a separate branding implement;

FIG. 5 is a top view of further molds in accordance with the invention one having the separate branding implement inserted therein; and

FIG. 6 is a view of a separate branding element made from lightweight plastic.

### DETAILED DESCRIPTION OF THE INVENTION

In order to more clearly understand the present invention part numbers as assigned in the following parts list will be used:

| Part Number | Description |
|---|---|
| 1 | mold |
| 3 | base |
| 4, 5 | end walls |
| 7, 8 | side walls |
| 10 | cavity |
| 12 | integral branding element |
| 14 | separate branding element |
| 16 | recesses specific to logo |
| 18 | lightweight branding element |

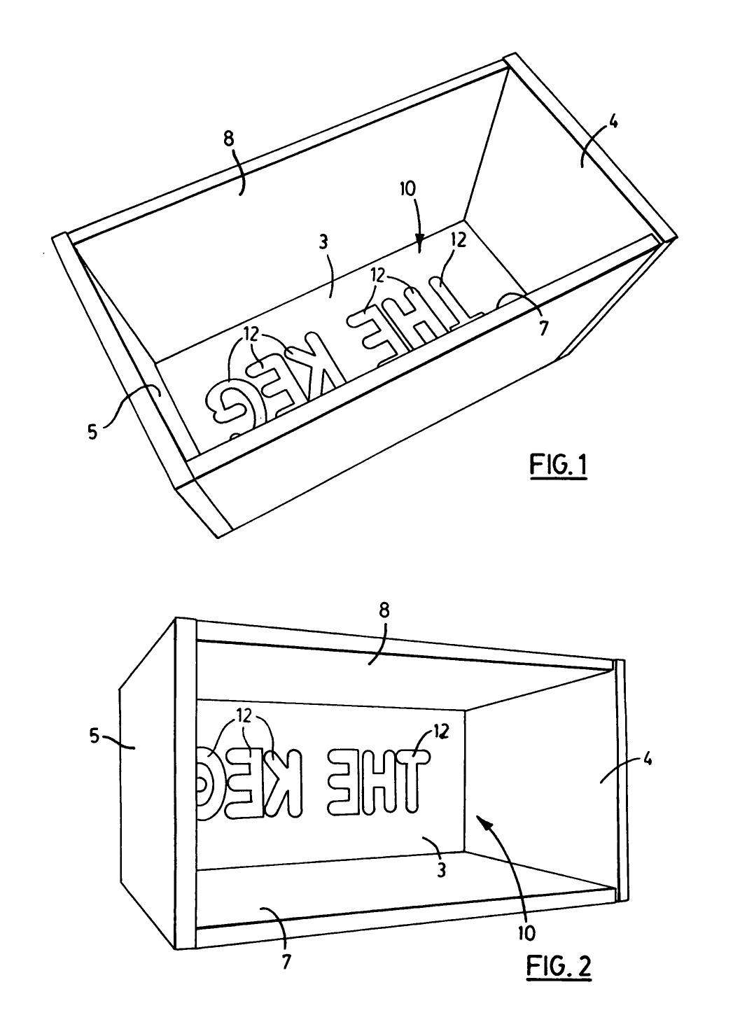

As seen in FIGS. 1 and 2, a mold according to the invention can have a base 3 defined between two side walls 7 and 8 and bounded by a pair of end walls 4 and 5 that together form an elongated and upwardly open cavity 10.

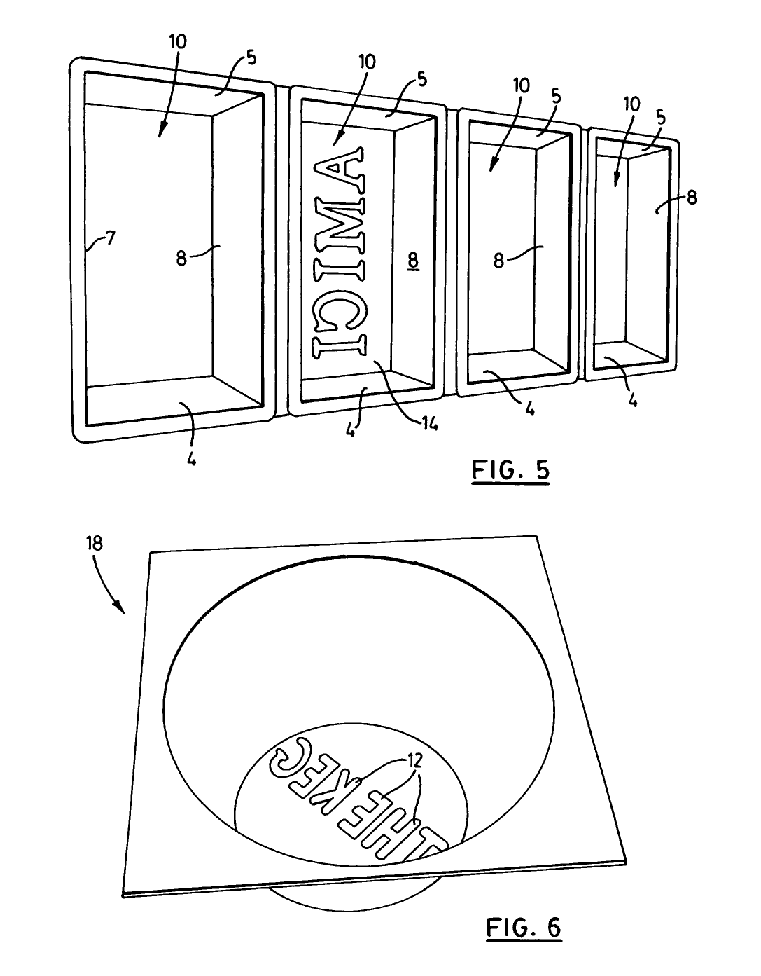

FIG. 5 shows how a plurality of such molds can be joined together to form an multiple-cavity mold.

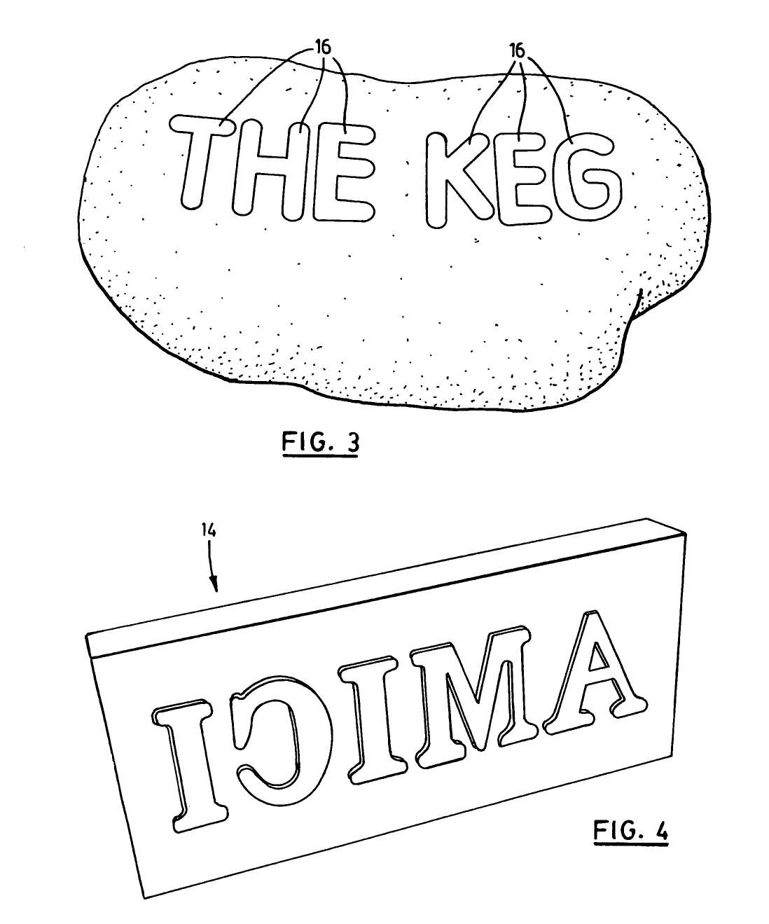

According to the invention as shown in FIG. 1 and FIG. 2a branded foodstuff is made by first pouring risable bread or cake dough into the mold cavity of a mold. The dough is baked and rises into a branding element 12 so a logo is formed as shown in FIG. 3. In this embodiment the branding element is integral to the mold in that recesses are formed into the base 3.

FIG. 4 and FIG. 5 show a separate branding element 14 made of food-grade plastic. In FIG. 5 the separate branding element 14 is shown placed in the base of a standard bread mold cavity. The branding element has recesses 16 into which the dough will rise when baked.

FIG. 6 shows a combined mold insert/liner and branding element 18 made from light weight plastic.

In operation the dough is placed into a mold with either an integral branding element or in a mold into which a separate branding element has been added. The branding element can be located below, beside or on top of the dough, and also may be introduced at different points in the baking process. The dough is then either fully or partially baked. In either case the dough rises against the protrusions (not shown) or into the recesses in the branding element. The food product is then demolded. Partially baked products can be flash frozen for distribution and final baking at a customers premises. Fully baked products will require only pre-heating via a customer.

It will be understood that modifications can be made in the embodiments and method of the invention described herein.

1. A method of making a branded cake, cookie or bread, the method comprising the steps of sequentially; filling the cavity of a mold with a mass of risable dough; before or after some rising of the dough adding a branding implement adjacent the dough mass; cooking the dough mass with the branding item so the dough rises and expands into the branding element; demolding the cooked dough mass from the mold; and exposing the branded foodstuff.

2. The method of claim 1 where the branding element is integral to the mold.

3. The method of claim 1 where the branding element is provided with recesses into which the dough will expand when cooked, leaving protrusions on the surface of the baked foodstuff.

4. The method of claim 1 where the branding element is provided with protrusions against which the dough will form when cooked, leaving recesses on the surface of the baked foodstuff.

5. A mold for a baked foodstuff having, a cavity of suitable configuration for cakes, cookies, breads and the like, said mold having a branding element with protrusions or recesses against which the foodstuff will expand when cooked to provide a branded foodstuff.
